(19) United States
(12) Patent Application Publication
(10) Pub. No.: US 2024/0056692 A1
(43) Pub. Date: Feb. 15, 2024

(54) FLICKER DETECTION

(71) Applicant: GoPro, Inc., San Mateo, CA (US)

(72) Inventors: Marc Lebrun, Issy-les-Moulineaux (FR); Océane Charlery, Villeurbanne (FR)

(21) Appl. No.: 18/231,870

(22) Filed: Aug. 9, 2023

Related U.S. Application Data
(60) Provisional application No. 63/396,707, filed on Aug. 10, 2022.

(51) Int. Cl. H04N 23/745; H04N 23/71

(52) U.S. Cl. CPC H04N 23/745; H04N 23/71

(57) ABSTRACT

A set of image portions is obtained. A pixel series that includes respective representative values of the image portions is obtained. Spectral data are obtained based on the pixel series. Significant local maxima are identified in the spectral data. An artificial light is determined to have been captured in the set of the image portions in response to determining that a number of the significant local maxima is greater than one. An anti-flicker feature of an image capture device is enabled. in response to determining that the artificial light is captured in the set of the image portions.

### CROSS REFERENCE TO RELATED APPLICATIONS

This application claims priority to U.S. Provisional Application No. 63/396,707, filed Aug. 10, 2022, which is incorporated herein in its entirety by reference.

### TECHNICAL FIELD

This disclosure relates generally to anti-flicker and more specifically to determining whether anti-flicker is to enabled based on whether artificial light is present.

### BACKGROUND

Flicker is an undesirable artifact in captured media (e.g., videos) and may be due to the presence of an artificial light source in an imaged scene. An image capture device may include anti-flicker features that may time the shooting (e.g., capture) of images to moments when flickering will have less of an impact. However, anti-flicker features may be enabled when flicker is not present in the imaged scene therewith unnecessarily constraining auto-exposure features of an image capture device.

### SUMMARY

Disclosed herein are implementations of flicker detection.

A first aspect of the disclosed implementations is a method that includes obtaining a set of image portions; obtaining a pixel series comprising respective representative values of the image portions; obtaining spectral data based on the pixel series; identifying significant local maxima in the spectral data; determining that an artificial light is captured in the set of the image portions in response to determining that a number of the significant local maxima is greater than one; and enabling an anti-flicker feature of an image capture device in response to determining that the artificial light is captured in the set of the image portions.

A second aspect of the disclosed implementations is an image capture device that includes a processor that is configured to execute instructions to obtain spectral data from image data of a scene captured by the image capture device; determine, based on the spectral data, that artificial light exists in the scene; and, in response to the determination that the artificial light exists in the scene, activate an anti-flicker function of the image capture device.

A third aspect of the disclosed implementations is a non-transitory computer readable medium that stores instructions operable to cause one or more processors to perform operations to obtain spectral data based on a pixel series, where the pixel series includes respective representative values corresponding to image portions; identify significant local maxima in the spectral data; and configure an anti-flicker feature of an image capture device in response a determination that a number of the significant local maxima is greater than one.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are isometric views of an example of an image capture device.

FIGS. 2A-2B are isometric views of another example of an image capture device.

FIG. 2C is a top view of the image capture device of FIGS. 2A-2B.

FIG. 2D is a partial cross-sectional view of the image capture device of FIG. 2C.

FIG. 3 is a block diagram of electronic components of an image capture device.

FIG. 4 is an example of a flowchart of a technique for activating an anti-flicker function of an image capture device.

FIG. 5 illustrates an example of an image sensor showing flicker estimation pixels.

FIGS. 6A-6B illustrate examples of spectrum graphs showing characteristics of natural light and artificial light.

FIG. 7 is an example of a flowchart of a technique for flicker detection.

FIG. 8 is a flowchart of a technique for identifying significant local maxima in spectral data.

FIG. 9 illustrates examples of spectral data obtained from pixel series.

FIG. 10 is a flowchart of a technique for identifying a frequency of an artificial power source based on an alias frequency.

### DETAILED DESCRIPTION

While light from an artificial light source (such as fluorescent or light-emitting diode (LED) lighting) may appear continuous to the human eye, in reality, the artificial light source may actually illuminate using high frequency pulses of light, which manifests as flicker in media, such as videos, captured by a media capture device (e.g., a camera or another hand-held device). Flicker is due to differences in exposure from one frame to another. Flicker can impact the quality of captured media and may be due to changing light conditions from one image (e.g., frame) to the next in a captured video. Flicker may appear to a viewer as flashing or moving lines. Flicker can be distracting and can be uncomfortable for many viewers.

Media capture devices may include or implement anti-flicker features. In one configuration, the anti-flicker feature of a media capture device may operate in a binary mode. That is, the anti-flicker feature may be either turned on or off (such as by an operator of the media capture device) and, when turned on, operates regardless of whether an artificial light source is present in the scene being captured. That is, the media capture device may be configured to always perform anti-flicker. As such, anti-flicker may always be applied regardless of the lighting conditions and regardless of whether anti-flicker is required under current capture conditions.

At a high level, an anti-flicker feature attempts to counteract flicker or blinking from artificial light sources and may time media capture to moments when flick will have less of an impact. The anti-flicker feature of a media capture device may be set (e.g., configured) to a frequency that is based on the location of use of the media capture. For example, in certain countries (e.g., in European countries), electric power may be generated at 50 Hertz (Hz), while in other countries (e.g., in the United States), electric power may be generated at 60 Hz. As such, the frequency of the anti-flicker may depend on the location of use or purchase of the image capture device. To illustrate, the anti-flicker feature may use a capture frame rate that is appropriate for the frequency of the artificial light. For example, a frame rate of 30 or 60 frames per second may be used for 60 Hz artificial light; whereas a higher frame rate may not result in eliminating or at least reducing the flicker. For brevity, the disclosure herein may use statements such as “the light frequency is X,” which should be understood to mean that “the light exhibits an X Hz modulation or flicker,” “the light flickers at a frequency of X Hz, synchronized with the frequency of the power source,” or the like.

While applying anti-flicker may improve image quality over not using anti-flicker, anti-flicker may negatively impact auto-exposure features (e.g., capabilities or algorithms) of the media capture device. For example, the anti-flicker feature may constrain the exposure time to be within some constrained values. This is so even if the media is captured under natural lighting conditions (e.g., outdoors) and in the absence of artificial lights. To illustrate, assume that an artificial lighting source operates at a certain frequency (e.g., 60 Hz). As such, the shutter of the media capture device cannot be at a multiple of the certain frequency. At best, the auto-exposure feature is constrained to close the shutter at a multiple of the fraction of the flicker frequency. To get around the flickering problem, the capture frame rate may be set to match the frequency of the artificial light. That is, the frame rate may be set to a rate that is divisible by the number of light pulses. To illustrate, in an area where the artificial light operates at 60 Hz, the capture frame rate may be set to 30, 60 or 120 frames-per-second (fps).

Artificial light may also result in banding artifacts due to what is referred to as the rolling shutter effect, which results in exposure differences from one row to another. Typically, not all parts of an image of a scene are recorded at exactly the same instant; rather, the image is captured by scanning across the scene rapidly (such as, for example, vertically or horizontally). To reduce the banding artefacts, the auto-exposure feature may use an exposure time that is greater than or equal to a multiple of half of the period of the artificial light (e.g., 1/2×frequency). However, when the anti-flicker feature is activated, the auto-exposure feature may be limited to set the exposure time to a multiple of twice the power frequency. For example, using a 60 Hz power source, the exposure times may be set to a multiple of 1/2×60=8.33 ms.

Implementations of this disclosure can determine whether an anti-flicker feature is be activated by automatically detecting whether artificial light is present in a scene. A difference between natural light and artificial light is that, whereas an artificial light may flicker at a certain frequency, a natural light source does not flicker. As such, an anti-flickering feature of an image capture device can be enabled responsive to detecting a light source that may be oscillating according to a frequency. Implementations of this disclosure can also determine the frequency at which the anti-flicker feature is to be performed based on a determined frequency of the artificial light. The frequency (i.e., a frequency associated with an artificial light) of a light source that generates the artificial light can be identified based on significant local maxima in spectral data obtained from images (e.g., image portions). A number of the significant local maxima in the spectral data. The images are determined to include artificial light if the number of significant local maxima is greater than one.

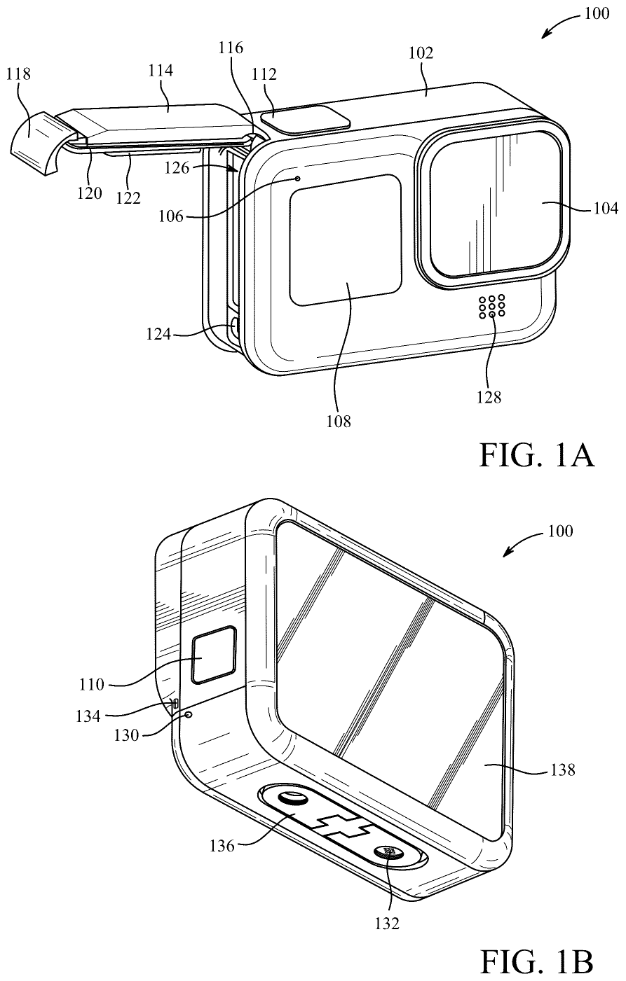

FIGS. 1A-1B are isometric views of an example of an image capture device 100. The image capture device 100 may include a body 102, a lens 104 structured on a front surface of the body 102, various indicators on the front surface of the body 102 (such as light-emitting diodes (LEDs), displays, and the like), various input mechanisms (such as buttons, switches, and/or touch-screens), and electronics (such as imaging electronics, power electronics, etc.) internal to the body 102 for capturing images via the lens 104 and/or performing other functions. The lens 104 is configured to receive light incident upon the lens 104 and to direct received light onto an image sensor internal to the body 102. The image capture device 100 may be configured to capture images and video and to store captured images and video for subsequent display or playback.

The image capture device 100 may include an LED or another form of indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal 120 and a battery interface 122. When the door 114 is an open position, access is provided to an input-output (I/O) interface 124 for connecting to or communicating with external devices as described below and to a battery receptacle 126 for placement and replacement of a battery (not shown). The battery receptacle 126 includes operative connections (not shown) for power transfer between the battery and the image capture device 100. When the door 114 is in a closed position, the seal 120 engages a flange (not shown) or other interface to provide an environmental seal, and the battery interface 122 engages the battery to secure the battery in the battery receptacle 126. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 on a front surface and another microphone 130 on a side surface. The image capture device 100 may include other microphones on other surfaces (not shown). The microphones 128, 130 may be configured to receive and record audio signals in conjunction with recording video or separate from recording of video. The image capture device 100 may include a speaker 132 on a bottom surface of the image capture device 100. The image capture device 100 may include other speakers on other surfaces (not shown). The speaker 132 may be configured to play back recorded audio or emit sounds associated with notifications.

A front surface of the image capture device 100 may include a drainage channel 134. A bottom surface of the image capture device 100 may include an interconnect mechanism 136 for connecting the image capture device 100 to a handle grip or other securing device. In the example shown in FIG. 1B, the interconnect mechanism 136 includes folding protrusions configured to move between a nested or collapsed position as shown and an extended or open position (not shown) that facilitates coupling of the protrusions to mating protrusions of other devices such as handle grips, mounts, clips, or like devices.

The image capture device 100 may include an interactive display 138 that allows for interaction with the image capture device 100 while simultaneously displaying information on a surface of the image capture device 100.

The image capture device 100 of FIGS. 1A-1B includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may include various types of image sensors, such as charge-coupled device (CCD) sensors, active pixel sensors (APS), complementary metal—oxide— semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera system-on-chip (SoC), etc.), which may be included on one or more circuit boards within the body 102 of the image capture device 100.

The image capture device 100 may interface with or communicate with an external device, such as an external user interface device (not shown), via a wired or wireless computing communication link (e.g., the I/O interface 124). Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the external user interface device via the computing communication link, and the external user interface device may store, process, display, or a combination thereof the panoramic images.

The external user interface device may be a computing device, such as a smartphone, a tablet computer, a phablet, a smart watch, a portable computer, personal computing device, and/or another device or combination of devices configured to receive user input, communicate information with the image capture device 100 via the computing communication link, or receive user input and communicate information with the image capture device 100 via the computing communication link.

The external user interface device may display, or otherwise present, content, such as images or video, acquired by the image capture device 100. For example, a display of the external user interface device may be a viewport into the three-dimensional space represented by the panoramic images or video captured or created by the image capture device 100.

The external user interface device may communicate information, such as metadata, to the image capture device 100. For example, the external user interface device may send orientation information of the external user interface device with respect to a defined coordinate system to the image capture device 100, such that the image capture device 100 may determine an orientation of the external user interface device relative to the image capture device 100.

Based on the determined orientation, the image capture device 100 may identify a portion of the panoramic images or video captured by the image capture device 100 for the image capture device 100 to send to the external user interface device for presentation as the viewport. In some implementations, based on the determined orientation, the image capture device 100 may determine the location of the external user interface device and/or the dimensions for viewing of a portion of the panoramic images or video.

The external user interface device may implement or execute one or more applications to manage or control the image capture device 100. For example, the external user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the external user interface device, such as via an application, may remotely control the image capture device 100 such as in response to user input.

The external user interface device, such as via an application, may display unprocessed or minimally processed images or video captured by the image capture device 100 contemporaneously with capturing the images or video by the image capture device 100, such as for shot framing or live preview, and which may be performed in response to user input. In some implementations, the external user interface device, such as via an application, may mark one or more key moments contemporaneously with capturing the images or video by the image capture device 100, such as with a tag or highlight in response to a user input or user gesture.

The external user interface device, such as via an application, may display or otherwise present marks or tags associated with images or video, such as in response to user input. For example, marks may be presented in a camera roll application for location review and/or playback of video highlights.

The external user interface device, such as via an application, may wirelessly control camera software, hardware, or both. For example, the external user interface device may include a web-based graphical interface accessible by a user for selecting a live or previously recorded video stream from the image capture device 100 for display on the external user interface device.

The external user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

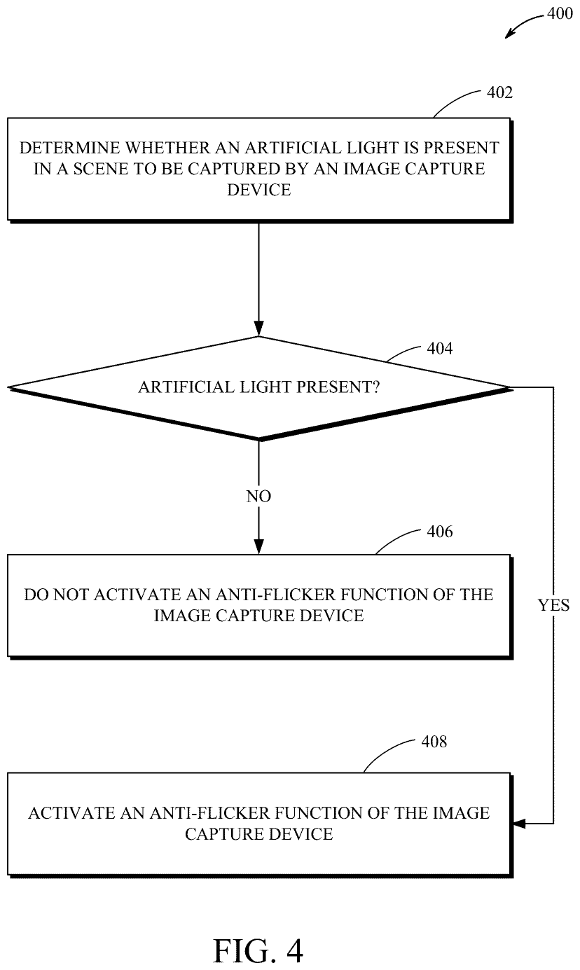

The image capture device 100 may be used to implement some or all of the techniques described in this disclosure, such as the technique 400 described in FIG. 4.

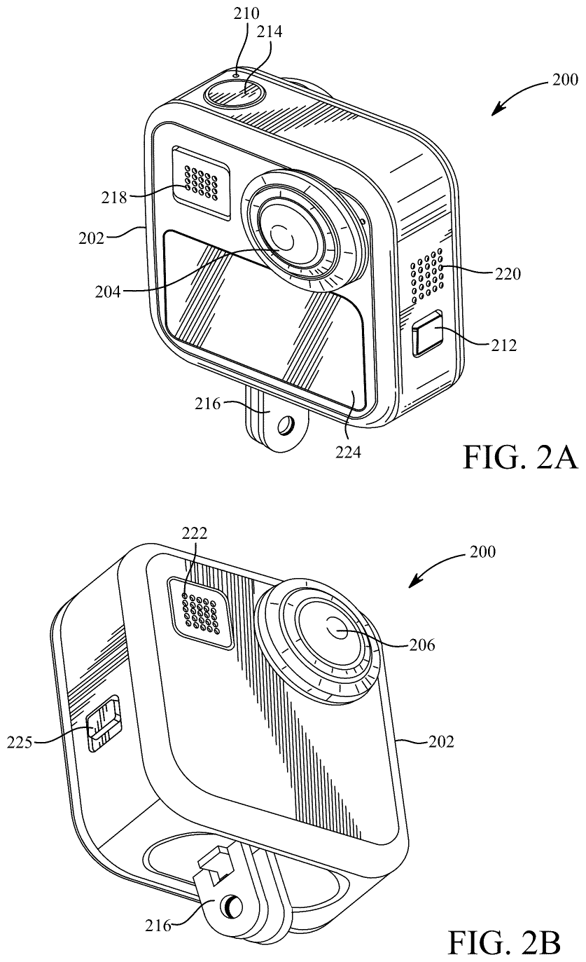

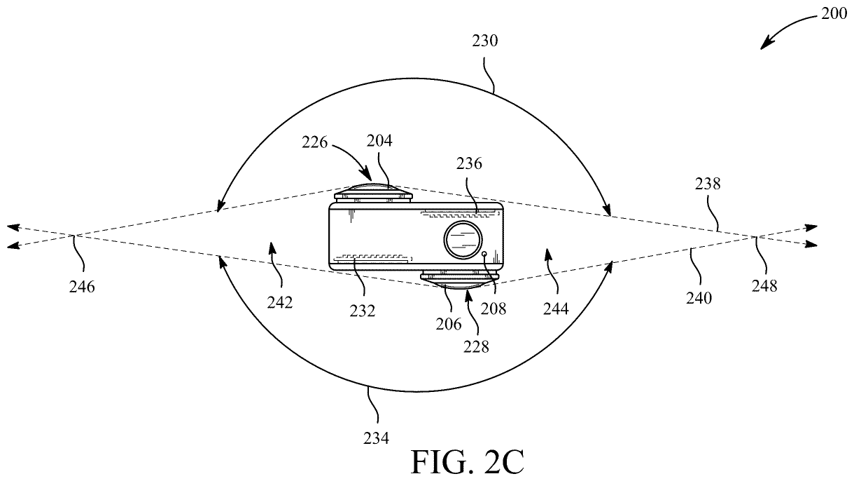

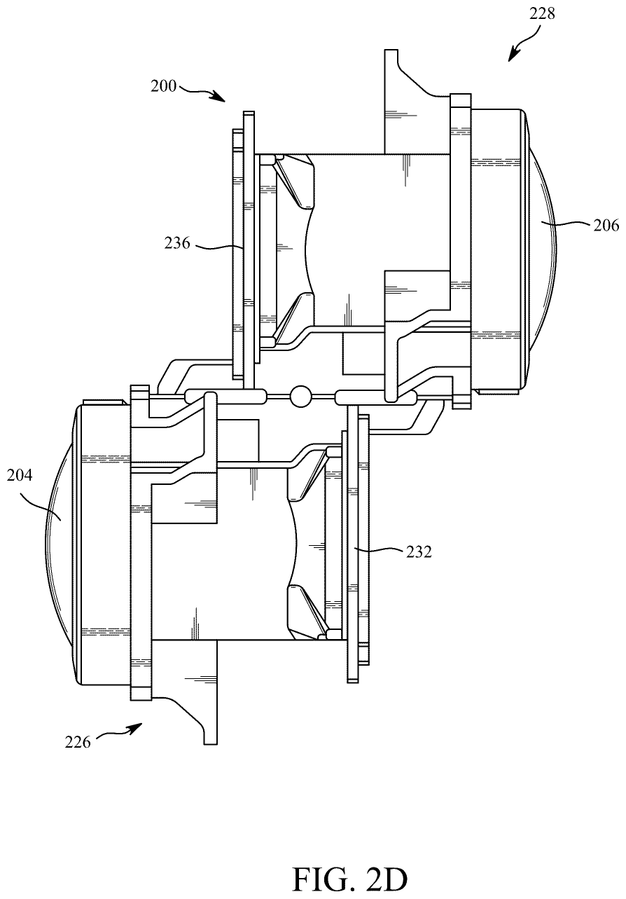

FIGS. 2A-2B illustrate another example of an image capture device 200. The image capture device 200 includes a body 202 and two camera lenses 204 and 206 disposed on opposing surfaces of the body 202, for example, in a back-to-back configuration, Janus configuration, or offset Janus configuration. The body 202 of the image capture device 200 may be made of a rigid material such as plastic, aluminum, steel, or fiberglass.

The image capture device 200 includes various indicators on the front of the surface of the body 202 (such as LEDs, displays, and the like), various input mechanisms (such as buttons, switches, and touch-screen mechanisms), and electronics (e.g., imaging electronics, power electronics, etc.) internal to the body 202 that are configured to support image capture via the two camera lenses 204 and 206 and/or perform other imaging functions.

The image capture device 200 includes various indicators, for example, LEDs 208, 210 to indicate a status of the image capture device 100. The image capture device 200 may include a mode button 212 and a shutter button 214 configured to allow a user of the image capture device 200 to interact with the image capture device 200, to turn the image capture device 200 on, and to otherwise configure the operating mode of the image capture device 200. It should be appreciated, however, that, in alternate embodiments, the image capture device 200 may include additional buttons or inputs to support and/or control additional functionality.

The image capture device 200 may include an interconnect mechanism 216 for connecting the image capture device 200 to a handle grip or other securing device. In the example shown in FIGS. 2A and 2B, the interconnect mechanism 216 includes folding protrusions configured to move between a nested or collapsed position (not shown) and an extended or open position as shown that facilitates coupling of the protrusions to mating protrusions of other devices such as handle grips, mounts, clips, or like devices.

The image capture device 200 may include audio components 218, 220, 222 such as microphones configured to receive and record audio signals (e.g., voice or other audio commands) in conjunction with recording video. The audio component 218, 220, 222 can also be configured to play back audio signals or provide notifications or alerts, for example, using speakers. Placement of the audio components 218, 220, 222 may be on one or more of several surfaces of the image capture device 200. In the example of FIGS. 2A and 2B, the image capture device 200 includes three audio components 218, 220, 222, with the audio component 218 on a front surface, the audio component 220 on a side surface, and the audio component 222 on a back surface of the image capture device 200. Other numbers and configurations for the audio components are also possible.

The image capture device 200 may include an interactive display 224 that allows for interaction with the image capture device 200 while simultaneously displaying information on a surface of the image capture device 200. The interactive display 224 may include an I/O interface, receive touch inputs, display image information during video capture, and/or provide status information to a user. The status information provided by the interactive display 224 may include battery power level, memory card capacity, time elapsed for a recorded video, etc.

The image capture device 200 may include a release mechanism 225 that receives a user input to in order to change a position of a door (not shown) of the image capture device 200. The release mechanism 225 may be used to open the door (not shown) in order to access a battery, a battery receptacle, an I/O interface, a memory card interface, etc. (not shown) that are similar to components described in respect to the image capture device 100 of FIGS. 1A and 1B.

In some embodiments, the image capture device 200 described herein includes features other than those described. For example, instead of the I/O interface and the interactive display 224, the image capture device 200 may include additional interfaces or different interface features. For example, the image capture device 200 may include additional buttons or different interface features, such as interchangeable lenses, cold shoes, and hot shoes that can add functional features to the image capture device 200.

FIG. 2C is a top view of the image capture device 200 of FIGS. 2A-2B and FIG. 2D is a partial cross-sectional view of the image capture device 200 of FIG. 2C. The image capture device 200 is configured to capture spherical images, and accordingly, includes a first image capture device 226 and a second image capture device 228. The first image capture device 226 defines a first field-of-view 230 and includes the lens 204 that receives and directs light onto a first image sensor 232. Similarly, the second image capture device 228 defines a second field-of-view 234 and includes the lens 206 that receives and directs light onto a second image sensor 236. To facilitate the capture of spherical images, the image capture devices 226 and 228 (and related components) may be arranged in a back-to-back (Janus) configuration such that the lenses 204, 206 face in generally opposite directions.

The fields-of-view 230, 234 of the lenses 204, 206 are shown above and below boundaries 238, 240 indicated in dotted line. Behind the first lens 204, the first image sensor 232 may capture a first hyper-hemispherical image plane from light entering the first lens 204, and behind the second lens 206, the second image sensor 236 may capture a second hyper-hemispherical image plane from light entering the second lens 206.

One or more areas, such as blind spots 242, 244 may be outside of the fields-of-view 230, 234 of the lenses 204, 206 so as to define a “dead zone.” In the dead zone, light may be obscured from the lenses 204, 206 and the corresponding image sensors 232, 236, and content in the blind spots 242, 244 may be omitted from capture. In some implementations, the image capture devices 226, 228 may be configured to minimize the blind spots 242, 244.

The fields-of-view 230, 234 may overlap. Stitch points 246, 248 proximal to the image capture device 200, that is, locations at which the fields-of-view 230, 234 overlap, may be referred to herein as overlap points or stitch points. Content captured by the respective lenses 204, 206 that is distal to the stitch points 246, 248 may overlap.

Images contemporaneously captured by the respective image sensors 232, 236 may be combined to form a combined image. Generating a combined image may include correlating the overlapping regions captured by the respective image sensors 232, 236, aligning the captured fields-of-view 230, 234, and stitching the images together to form a cohesive combined image.

A slight change in the alignment, such as position and/or tilt, of the lenses 204, 206, the image sensors 232, 236, or both, may change the relative positions of their respective fields-of-view 230, 234 and the locations of the stitch points 246, 248. A change in alignment may affect the size of the blind spots 242, 244, which may include changing the size of the blind spots 242, 244 unequally.

Incomplete or inaccurate information indicating the alignment of the image capture devices 226, 228, such as the locations of the stitch points 246, 248, may decrease the accuracy, efficiency, or both of generating a combined image. In some implementations, the image capture device 200 may maintain information indicating the location and orientation of the lenses 204, 206 and the image sensors 232, 236 such that the fields-of-view 230, 234, the stitch points 246, 248, or both may be accurately determined; the maintained information may improve the accuracy, efficiency, or both of generating a combined image.

The lenses 204, 206 may be laterally offset from each other, may be off-center from a central axis of the image capture device 200, or may be laterally offset and off-center from the central axis. As compared to image capture devices with back-to-back lenses, such as lenses aligned along the same axis, image capture devices including laterally offset lenses may include substantially reduced thickness relative to the lengths of the lens barrels securing the lenses. For example, the overall thickness of the image capture device 200 may be close to the length of a single lens barrel as opposed to twice the length of a single lens barrel as in a back-to-back lens configuration. Reducing the lateral distance between the lenses 204, 206 may improve the overlap in the fields-of-view 230, 234. In another embodiment (not shown), the lenses 204, 206 may be aligned along a common imaging axis.

Images or frames captured by the image capture devices 226, 228 may be combined, merged, or stitched together to produce a combined image, such as a spherical or panoramic image, which may be an equirectangular planar image. In some implementations, generating a combined image may include use of techniques including noise reduction, tone mapping, white balancing, or other image correction. In some implementations, pixels along the stitch boundary may be matched accurately to minimize boundary discontinuities.

The image capture device 200 may be used to implement some or all of the techniques described in this disclosure, such as the technique 400 described in FIG. 4.

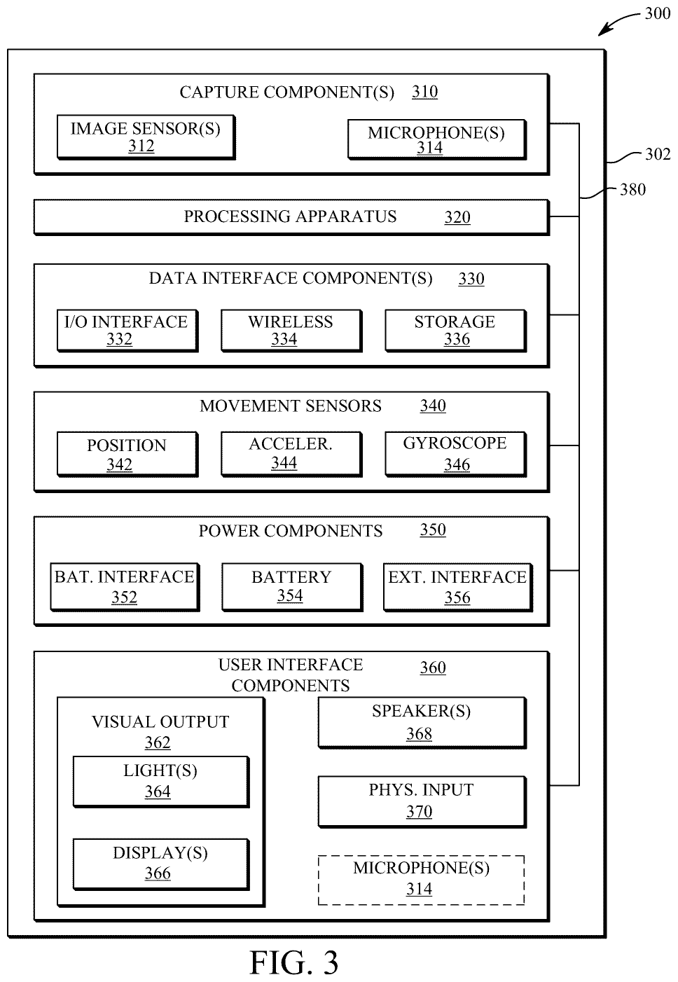

FIG. 3 is a block diagram of electronic components in an image capture device 300. The image capture device 300 may be a single-lens image capture device, a multi-lens image capture device, or variations thereof, including an image capture device with multiple capabilities such as use of interchangeable integrated sensor lens assemblies. The description of the image capture device 300 is also applicable to the image capture devices 100, 200 of FIGS. 1A-1B and 2A-2D.

The image capture device 300 includes a body 302 which includes electronic components such as capture components 310, a processing apparatus 320, data interface components 330, movement sensors 340, power components 350, and/or user interface components 360.

The capture components 310 include one or more image sensors 312 for capturing images and one or more microphones 314 for capturing audio.

The image sensor(s) 312 is configured to detect light of a certain spectrum (e.g., the visible spectrum or the infrared spectrum) and convey information constituting an image as electrical signals (e.g., analog or digital signals). The image sensor(s) 312 detects light incident through a lens coupled or connected to the body 302. The image sensor(s) 312 may be any suitable type of image sensor, such as a charge-coupled device (CCD) sensor, active pixel sensor (APS), complementary metal-oxide-semiconductor (CMOS) sensor, N-type metal—oxide— semiconductor (NMOS) sensor, and/or any other image sensor or combination of image sensors. Image signals from the image sensor(s) 312 may be passed to other electronic components of the image capture device 300 via a bus 380, such as to the processing apparatus 320. In some implementations, the image sensor(s) 312 includes a digital-to-analog converter. A multi-lens variation of the image capture device 300 can include multiple image sensors 312.

The microphone(s) 314 is configured to detect sound, which may be recorded in conjunction with capturing images to form a video. The microphone(s) 314 may also detect sound in order to receive audible commands to control the image capture device 300.

The processing apparatus 320 may be configured to perform image signal processing (e.g., filtering, tone mapping, stitching, and/or encoding) to generate output images based on image data from the image sensor(s) 312. The processing apparatus 320 may include one or more processors having single or multiple processing cores. In some implementations, the processing apparatus 320 may include an application specific integrated circuit (ASIC). For example, the processing apparatus 320 may include a custom image signal processor. The processing apparatus 320 may exchange data (e.g., image data) with other components of the image capture device 300, such as the image sensor(s) 312, via the bus 380.

The processing apparatus 320 may include memory, such as a random-access memory (RAM) device, flash memory, or another suitable type of storage device, such as a non-transitory computer-readable memory. The memory of the processing apparatus 320 may include executable instructions and data that can be accessed by one or more processors of the processing apparatus 320. For example, the processing apparatus 320 may include one or more dynamic random-access memory (DRAM) modules, such as double data rate synchronous dynamic random-access memory (DDR SDRAM). In some implementations, the processing apparatus 320 may include a digital signal processor (DSP). More than one processing apparatus may also be present or associated with the image capture device 300.

The data interface components 330 enable communication between the image capture device 300 and other electronic devices, such as a remote control, a smartphone, a tablet computer, a laptop computer, a desktop computer, or a storage device. For example, the data interface components 330 may be used to receive commands to operate the image capture device 300, transfer image data to other electronic devices, and/or transfer other signals or information to and from the image capture device 300. The data interface components 330 may be configured for wired and/or wireless communication. For example, the data interface components 330 may include an I/O interface 332 that provides wired communication for the image capture device, which may be a USB interface (e.g., USB type-C), a high-definition multimedia interface (HDMI), or a FireWire interface. The data interface components 330 may include a wireless data interface 334 that provides wireless communication for the image capture device 300, such as a Bluetooth interface, a ZigBee interface, and/or a Wi-Fi interface. The data interface components 330 may include a storage interface 336, such as a memory card slot configured to receive and operatively couple to a storage device (e.g., a memory card) for data transfer with the image capture device 300 (e.g., for storing captured images and/or recorded audio and video).

The movement sensors 340 may detect the position and movement of the image capture device 300. The movement sensors 340 may include a position sensor 342, an accelerometer 344, or a gyroscope 346. The position sensor 342, such as a global positioning system (GPS) sensor, is used to determine a position of the image capture device 300. The accelerometer 344, such as a three-axis accelerometer, measures linear motion (e.g., linear acceleration) of the image capture device 300. The gyroscope 346, such as a three-axis gyroscope, measures rotational motion (e.g., rate of rotation) of the image capture device 300. Other types of movement sensors 340 may also be present or associated with the image capture device 300.

The power components 350 may receive, store, and/or provide power for operating the image capture device 300. The power components 350 may include a battery interface 352 and a battery 354. The battery interface 352 operatively couples to the battery 354, for example, with conductive contacts to transfer power from the battery 354 to the other electronic components of the image capture device 300. The power components 350 may also include an external interface 356, and the power components 350 may, via the external interface 356, receive power from an external source, such as a wall plug or external battery, for operating the image capture device 300 and/or charging the battery 354 of the image capture device 300. In some implementations, the external interface 356 may be the I/O interface 332. In such an implementation, the I/O interface 332 may enable the power components 350 to receive power from an external source over a wired data interface component (e.g., a USB type-C cable).

The user interface components 360 may allow the user to interact with the image capture device 300, for example, providing outputs to the user and receiving inputs from the user. The user interface components 360 may include visual output components 362 to visually communicate information and/or present captured images to the user. The visual output components 362 may include one or more lights 364 and/or more displays 366. The display(s) 366 may be configured as a touch screen that receives inputs from the user. The user interface components 360 may also include one or more speakers 368. The speaker(s) 368 can function as an audio output component that audibly communicates information and/or presents recorded audio to the user. The user interface components 360 may also include one or more physical input interfaces 370 that are physically manipulated by the user to provide input to the image capture device 300. The physical input interfaces 370 may, for example, be configured as buttons, toggles, or switches. The user interface components 360 may also be considered to include the microphone(s) 314, as indicated in dotted line, and the microphone(s) 314 may function to receive audio inputs from the user, such as voice commands.

The image capture device 300 may be used to implement some or all of the techniques described in this disclosure, such as the technique 400 described in FIG. 4.

FIG. 4 is an example of a flowchart of a technique 400 for activating an anti-flicker function of an image capture device. The technique 400 can be implemented, for example, as a software program that may be executed by an image capture device, such as the image capture device 100 of FIGS. 1A-1B, the image capture device 200 of FIGS. 2A-2D, or image capture device 300 of FIG. 3. As such, the technique 400 can be implemented by a processing apparatus, such as the processing apparatus 320 of FIG. 3. The software program can include machine-readable instructions that may be stored in a memory of the processing apparatus, such a RAM device, flash memory, or another suitable type of storage device, such as a non-transitory computer-readable memory, and that, when executed by a processor, such as a processor of the processing apparatus, may cause the computing device to perform the technique 400. The technique 400 can be implemented using specialized hardware or firmware. Multiple processors, memories, or both, may be used.

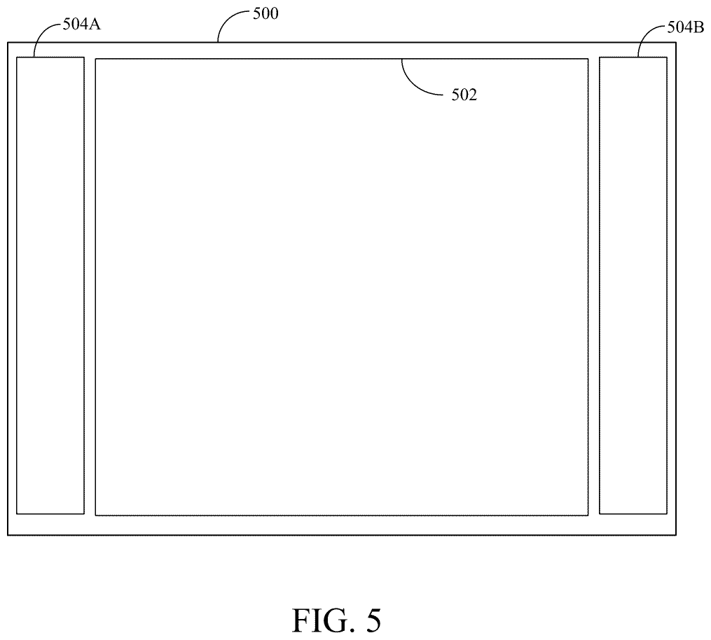

At 402, it is determined whether an artificial light is present in a scene to be captured (e.g., imaged) by the image capture device. Whether the artificial light is present in the scene can be determined by sampling pixels of preview images. The pixels used to estimate whether an artificial light is present in a scene may be referred to herein as “flicker estimation pixels.” “Flicker estimation pixels” may also be a referred to as an “image portion.” In an example, the flicker estimation pixels can be pixels that are outside of the field-of-view (FOV) of a lens (e.g., at least one lens) of the image capture device. The pixels that are outside of the field-of-view (FOV) of at least one lens of the image capture device are described with respect to FIG. 5. In an example, the pixels that are outside of the FOV of the lens may be pixels of an image sensor of the image capture device. In another example, the flicker estimation pixels can be pixels that are within the FOV, as further described herein.

FIG. 5 illustrates an example of an image sensor 500 showing flicker estimation pixels. As mentioned above, the flicker estimation pixels can be pixels that are outside of a FOV of a lens of an image capture device. The image sensor 500 may be arranged on an optical axis of a lens of the image capture device. The image sensor 500 may convert an object image formed by the lens into an image signal that may be output for further processing, as described above. The image sensor 500 may include photodiodes which constitute individual pixels arranged two-dimensionally in a matrix shape. The image sensor 500 may include an effective region 502 and one or more regions 504A-504B. An image sensor may include more or fewer 504 regions than those shown in FIG. 5. In an example, each of the one or more regions 504A-504B may be 32 pixels in width. That is, each of the one or more regions 504A-504B may include pixels arranged in rows that each includes 32 pixels. The one or more regions 504A-504B include pixels that are outside of the FOV and receive no light.

Returning again to FIG. 4, the flicker estimation pixels may be sampled using images obtained by the image capture device. For example, a set of images (e.g., a burst of images) may be obtained and image portions therefrom may be sampled. In an example, at least some of the images obtained by the image capture device may be preview images. As mentioned above, the image capture device may acquire preview images that may be used for shot framing or live preview. In an example, a time lapse may be obtained of the scene. As such, there can be a gap in time between images captured of the scene. During this gap in time, preview images may also be obtained. In another example, the image capture device may use previously captured images as preview images for flicker frequency detection. For example, the image capture device may be capturing a video. As such, at least some of the images (e.g., video frames) of the video may be used as the preview images.

In an example, sampling the pixels that are outside of the FOV of the lens can mean or include obtaining respective values of a subset of the rows of the pixel values of the regions 504A-504B of FIG. 5. By reading only a subset of the rows, the sampling can be performed more quickly than reading all the rows of the regions 504A-504B of FIG. 5. The reading speed of pixel values of the pixels may be proportional to the number of pixels that are read. As such, the fewer the pixels that are read, the faster that they can be read. Sampling image portions that are not outside of the FOV of the lens is further described below.

The flicker estimation pixels may be sampled at a frequency that is at least twice a maximum frequency of artificial light sources. That is, for example, the preview images may be obtained at a frequency that is twice the maximum frequency of artificial light sources. The maximum frequency of artificial light sources may depend on a location (e.g., country) where the preview images are being captured. As mentioned above, artificial light may be generated at different frequencies in different countries. As such, the maximum frequency may be determined based on a location of operation of the image capture device.

The frequency of sampling or capturing of the image portions should exceed twice the maximum flicking frequency of artificial light sources. If the frequency of the sampling or capturing of the preview images does not exceed twice the maximum flickering frequency, then the technique 400 may not have sufficient sampling data to detect (or correctly detect) the flickering frequency. To illustrate, if the artificial light source operates at 60 Hz, then the light would flicker at 120 Hz because the power fluctuates between negative and positive values and the artificial light would be on as both positive and negative values—the light source (i.e., an alternating current, or AC) flickers at both positive and negative cycles. Thus, typically the detected frequency would be twice the power frequency. As such, the flicker estimation pixels should be sampled at a frequency that is at least 120*2=240 Hz. By sampling at 240 Hz (i.e., at a frequency that is higher than twice the maximum flicker frequency of artificial light sources in the given location), enough data (e.g., samples) will be available to detect patterns (such as repetitions or sinusoidal waves) in the artificial light.

Accordingly, and as further described below, an image capture device can be configured to capture images of a scene at a frame rate that is at least equal twice the flicker frequency so that sufficient data are available to identify whether artificial light is present in the scene. For example, the frame rate can be 240 frames per second (fps). However, and as further described below, because of spectral aliasing, images (e.g., portions thereof) can be captured at a lower frequency. That is, for example, while for a power of 60 Hz, 240 (2×(2×60)) FPS would indeed enable detection of frequency peak at 120 Hz, because of aliasing, if the frame rate is correctly chosen so that the peak would not fold at 0 Hz, the frequency of artificial light in a scene can be detected using a frame rate that is lower than twice the flickering frequency.

In an example, determining the presence of the artificial light by sampling the flicker estimation pixels can include obtaining respective pixel value averages of the pixels corresponding to sampling events. In an example, the respective pixel value averages may be high-pass filtered. High pass filtering may be used to avoid detecting luminosity changes of the scene. That is, for each sampling event, a respective average is obtained. To illustrate, a sampling event includes the following steps: a preview image is obtained; a subset (e.g., 32 pixels x 5 rows=160 pixels) of the flicker estimation pixels are read; an average pixel value is obtained from the subset. In another example, a median pixel value may be used instead of the average. Based on the fluctuation of the light (i.e., because of the light flicker), the average pixel values may also fluctuate between different shades of black, that is, between different black values. As such, the fluctuations in the black values can be used to detect when the artificial light source emits light or the frequency of the artificial light.

A function may then be fit to the pixel value averages that are obtained. Alternatively, or equivalently, the pixel average values may be plotted (e.g., graphed). The frequency of the artificial light can be determined based on detecting a repetitive pattern in the function or the plotted pixel value averages. In an example, the repetitive pattern may be a sinusoidal-like fluctuation.

At 404, it is determined whether artificial light is detected to be present. In an example, a correlation may be applied to the pixel average values with the frequency of artificial light (e.g., a 100 Hz sine wave or a 120 Hz sine wave when there is no aliasing) to obtain a correlation index. If the correlation index is greater than a threshold, then an artificial light (i.e., flicker) is determined to be present at the frequency of the artificial light.

If no pattern is detected, then no artificial light is determined to be present and any fluctuations in the black values may be determined to be due or attributed to noise. If no artificial light is determined to be present in the scene, then, at 406, the anti-flicker function of the image capture device is not enabled (e.g., not activated) and, consequently, any auto-exposure functions (e.g., algorithms) of the image capture device are not constrained to be within tolerances or ranges set by the anti-flicker function.

On the other hand, if a pattern is detected, then it can be assumed that an artificial light is present in the scene and that the frequency of the artificial light is based on the pattern. As such, at 408, the anti-flicker function of the image capture device can be activated. The frequency of the anti-flicker function can be set to a frequency that is higher than a determined frequency of the artificial light. Furthermore, auto-exposure functions (e.g., algorithms) of the image capture device are constrained to be within tolerances or ranges set by the anti-flicker function. Activating the anti-flicker function can mean or include capturing (e.g., recording) images of the scene using a frame rate that is based on the frequency of the artificial light. As such, the technique 400 can set a frame rate of the image capture device where the frame rate is based on the pattern that is detected.

As mentioned above, the flicker frequency may be pre-determined (such as based on the location of use or a configuration of the image capture device). In an example, the pre-determined flicker frequency may be detected based on a global positioning system (GPS) location of the image capture device. The image capture device may include a lookup table that maps geolocations (e.g., regions, countries, etc.) to pre-determined frequencies. Thus, the GPS location of the image capture device can be used to look up the pre-determined frequency in the lookup table.

In an example, the technique 400 may simply output a flag (e.g., a Boolean) indicating whether the anti-flicker algorithm is to be enabled. As such, the technique 400 detects a pattern but may not estimate a frequency of the pattern. And the frequency of the anti-flicker feature may be set based on the pre-determined flicker frequency. In another example, the technique 400 may also determine whether the pattern has a frequency that is similar (e.g., close, approximately equal) to the pre-determined flicker frequency. To illustrate, if the technique 400 detects a pattern with a 35 Hz frequency, which may not be sufficiently close to the pre-determined frequency, then the technique 400 determines that no artificial light is present. In yet another example, the anti-flicker may be configured according to the pattern determined by the technique 400.

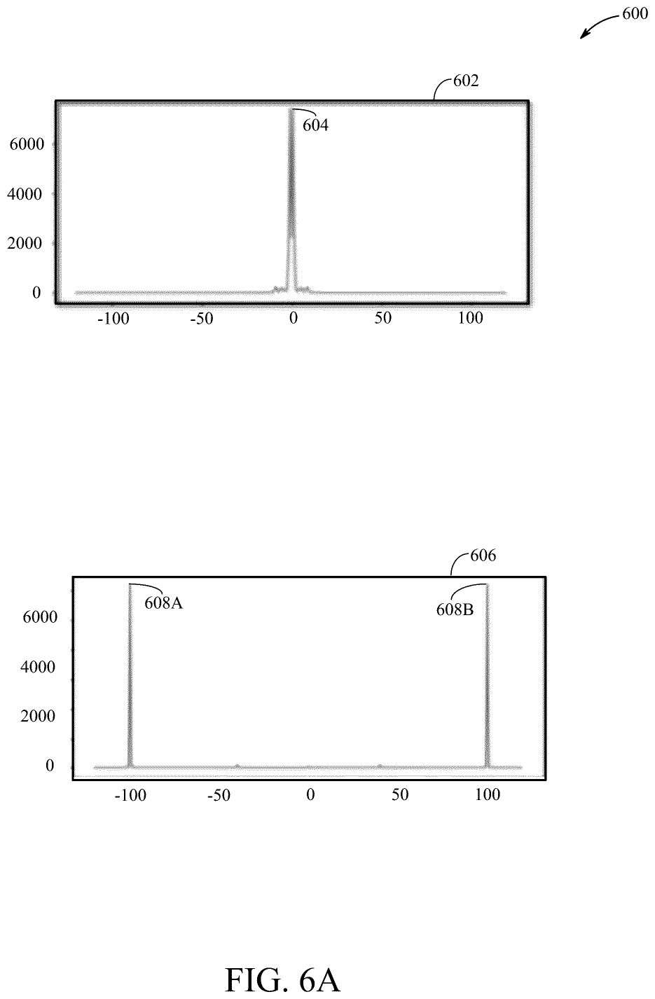

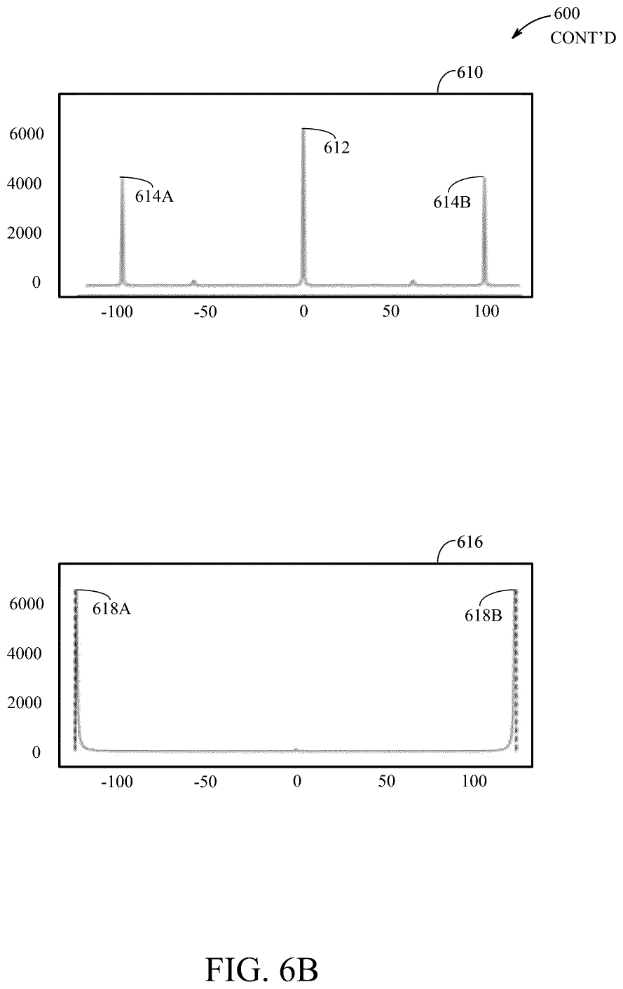

FIGS. 6A-6B illustrate examples 600 of spectrum graphs showing characteristics of natural light and artificial light. As is known, the Nyquist-Shannon sampling theorem states that the sampling frequency of a signal must be at least twice the highest frequency that is to be measured or detected. As such, and under ideal circumstances (where the scene includes a static background and a single light source, with no foreground elements or moving objects), the sampling rate should be at least double the highest frequency of the signal to precisely extract the illumination frequency from the sampled data. In this context, the highest frequency equates to the frequency of the light source, meaning that the sampling rate should be at least twice the light source's flicker rate. Therefore, the imaging device must capture images of the scene at a frame rate (expressed as frames per second, or fps) that matches or exceeds this required sampling rate. If the flicker frequency of the light source surpasses twice the frame rate (i.e., the sampling rate), a phenomenon known as aliasing may occur, potentially leading to inaccuracies in the frequency measurements. However, as further described herein, techniques can be used to estimate the flicker frequency even when the sampling rate is less than twice the flicker frequency.

As such, in a scene captured in Europe (where the light exhibits a 100 Hz modulation or flicker), an imaging device would be required to capture the scene at a minimum of 100 fps. If images were captured at a rate of 240 fps, then 5 periods (i.e., 240 fps/50 Hz) would be observed where the each period should have a peak of 50 Hz. Similarly, in a scene captured in the United States (where the light exhibits a 120 Hz modulation or flicker), an imaging device would be required to capture the scene at a minimum of 120 fps. If images were captured at a rate of 240 fps, then 4 periods (i.e., 240 fps/60 Hz) would be observed.

A frequency spectrum 602 of a sampled scene that includes only natural light indicates that a peak 604 (i.e., highest magnitude frequency) is located at the center of the frequency spectrum 602 in the Fast-Fourier Transform (FFT) (after shift) and that most frequency values are centered around 0. The frequency spectrum 602 is a graphical illustration of the output of an FFT applied to sampled image data (described below). Frequency values are shown on the x-axis and the amplitude (or magnitude) of each frequency is shown on the y-axis.

The frequency spectrum 602 illustrates that natural light (such as sunlight) is generally constant and, unlike artificial light, does not flicker at a frequency. Therefore, if a video only contains natural light, the intensity of which is analyzed overtime time using an FFT, a peak 604 would be observed at or near the zero frequency. A constant intensity over time corresponds to a frequency of zero in the FFT, indicating that there is no change (or a very slow change, considering the gradual change from day to night) in the light intensity over the time span of the video.

A frequency spectrum 606 of a sampled scene that includes only artificial light, and which is captured in Europe, indicates that peaks 608A and 608B (i.e., highest magnitude frequencies) are located at frequencies −100 Hz and 100 Hz, respectively. This is so because the light source (i.e., an alternating current, or AC) flickers at both positive and negative cycles. The frequency spectrum 606 illustrates that if there is a flickering light in the imaged scene, it will appear as a repeating pattern in the sampled data, which in turn translates to spikes or “peaks” at a certain frequencies in the FFT spectrum. The position(s) of the peak(s) on the x-axis indicate the frequency of the flicker.

To obtain the frequency of the light source, the high range peak is divided by two (because, again, when the power fluctuates, there are positive and negative values and the light pulses at both negative and positive peaks). Thus, the frequency at which the lights fluctuate or pulse is twice the frequency of the power supply of the power. Thus, the frequency of the light source corresponding to the frequency spectrum 606 is 50 Hz.

A frequency spectrum 610 of a sampled scene that includes both natural artificial and artificial light, and which is captured in Europe, indicates that peaks 614A and 614B corresponding to the frequency of the artificial light are located at frequencies −100 Hz and 100 Hz, respectively, and that a peak 612 corresponding to natural light is located at frequency 0. This is so because the light source (i.e., an alternating current, or AC) flickers at both positive and negative cycles. The frequency spectrum 610 corresponds to a video sequence captured at daytime. As such, natural light is more intense therewith resulting in the peak 612 being higher than the peaks 614A and 614B.

A frequency spectrum 616 of a sampled scene that includes only artificial light, and which is captured in the United States, indicates that peaks 618A and 618B (i.e., highest magnitude frequencies) are located at frequencies −120 Hz and 120 Hz, respectively. This is so because the AC light source flickers at both positive and negative cycles.

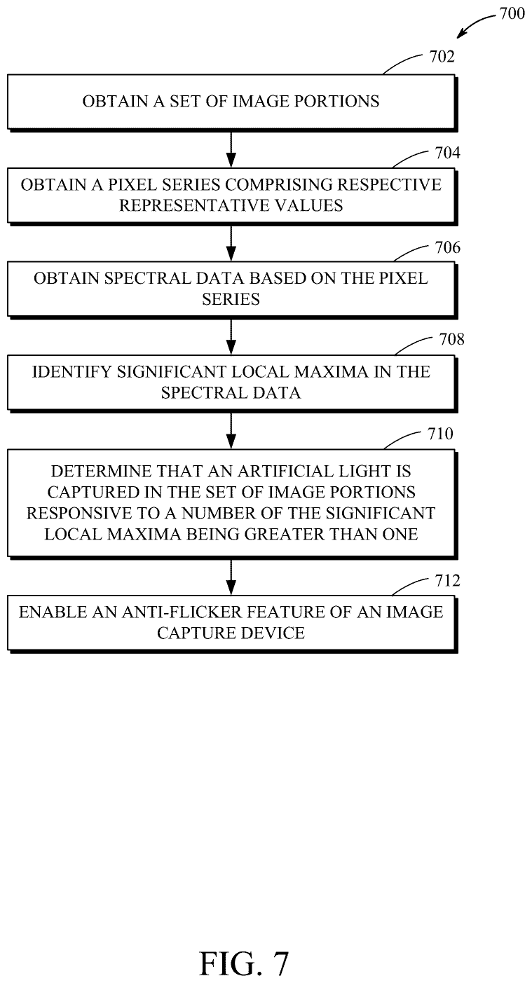

FIG. 7 is an example of a flowchart of a technique 700 for flicker detection. The technique 700 uses frequency domain data (e.g., analysis thereof) to identify whether artificial light exists in a scene. In an example, if artificial light is determined to exist in the scene, the frequency of the artificial light source can also be determined (e.g., estimated). The determination can be based on identifying significant local maxima in the magnitudes of the frequencies.

The technique 700 can be implemented, for example, as a software program that may be executed by an image (e.g., media) capture device (e.g., a camera), such as the image capture device 100 of FIGS. 1A-1B, the image capture device 200 of FIGS. 2A-2D, or image capture device 300 of FIG. 3. As such, the technique 700 can be implemented by a processing apparatus, such as the processing apparatus 320 of FIG. 3. The software program can include machine-readable instructions that may be stored in a memory of the processing apparatus, such a RAM device, flash memory, or another suitable type of storage device, such as a non-transitory computer-readable memory, and that, when executed by a processor, such as a processor of the processing apparatus, may cause the computing device to perform the technique 700. The technique 700 can be implemented using specialized hardware or firmware. Multiple processors, memories, or both, may be used.

At 702, a set of image portions is obtained. The set of image portions may be obtained from a burst of image portions. Each image portion includes respective flicker estimation pixels. In an example, each image portion can be a full image captured by the image capture device. In an example, and to reduce computational complexity, each image portion can be a portion (e.g., a subset) of a full image. The portions of the full images may be obtained by downscaling and/or cropping raw images. The raw images can be received or read directly from an image sensor of the image capture device. By downscaling and/or cropping raw images the total number of pixels to be obtained from the image sensor can be reduced therewith allowing for more flicker estimation pixels (i.e., image portions) to be obtained per burst. The image portions may be extracted from central portions of the corresponding images. The image portions may be extracted from peripheral portions (e.g., top right or top left) of the corresponding images.

As such, the image portions can be in a defined format, such as a format of the image sensor, which may also be referred to as “raw,” such as “a raw image,” “raw image data,” “raw data,” “a raw signal,” or “a raw image signal.” For example, the image portions (i.e., the raw image signals) may be in a format such as an RGB format, which may represent individual pixels using a combination of values or components, such as a red component (R), a green component (G), and a blue component (B). In another example, the raw image signal may be in a Bayer format, wherein a respective pixel may be one of a combination of adjacent pixels, such as a combination of four adjacent pixels of a Bayer pattern. Obtaining the image portions in the raw format reduces computation complexity.

In an example, and to reduce computational complexity, each of the image portions can include pixel data associated with only one of the color components. However, the techniques described herein are not so limited and the image portions can include pixel data of more than one color component. In an example, the only one of the color components can be the green (G) component due to the white balance in the green channel. The green channel (e.g., component) is generally brighter than the red (R) or blue (B) components. As such, it may be preferable to base the computations described herein on pixels (i.e., the pixel values) of the green component. In an example, the technique 700 may adjust the brightness or intensity values of the pixel data by applying a gamma correction. In an example, a gamma value of 2.2 may be used on the green (G) component.

A burst of images refers to the rapid capture of multiple consecutive photos by the image capture device in quick succession. The technique 700 may determine to obtain the burst of image portions in response to detecting an event consistent with image capture. That is, the technique 700 may determine to cause the image capture device to capture the burst of images in response to identifying (e.g., inferring) that the user of the image capture device intends to capture images. The burst of image portions can be based on a burst of 50, 300, or some other number of images, as further described herein.

That the user intends to capture images (e.g., a video) may be determined in response to the image capture device being turned on. That the user intends to capture images (e.g., a video) may be determined in response to the user touching an LCD screen of the image capture device. When the user touches the LCD display (whether the image capture device is or isn't in a sleep mode), an LCD touch event can be received. In an example, the user may touch the LCD display presumably because the user intends to frame a scene for capturing one or more images (e.g., a video). As such, the LCD touch event can indicate that the user is likely to capture a photo in the very near future.

In an example, the image capture device may be laid idly, such as on a table. When the user picks up the image capture device, a pick-up event can be received. The pick-up event can indicate that the user is likely to capture a photo or video in the very near future. The pick-up event can be detected based on sensor information. For example, sensor information from an inertial measurement unit (IMU), a global positioning system (GPS) receiver, a gyroscope, other sensors, or a combination thereof, can be used to detect that the image capture device has moved from a stationary position.

In an example, the burst of images (from which the image portions are obtained) may be captured by the image capture device at a frame rate of at least 240 fps so that artificial light frequencies of 50 Hz or 60 Hz can be identified. Other frame rates are possible, as further described below.

At 704, a pixel series is obtained from the image portions. In an example, for each of the color components of an image portion a representative pixel value is obtained. Thus, if each image portion includes pixels of one color component, then one representative pixel value (i.e., a representative value) is obtained from the image portion. In an example, the representative pixel value of an image portion can be the average (i.e., average pixel value) of all of the pixels (i.e., of all of the pixel values) of the image portion. As such, the pixel series includes the averages of the pixel values of the image portions. In another example, the representative value can be the median value. As such, the pixel series includes the medians of the pixel values of the image portions.

Generally, it may be preferable to use the median values over the mean values because the median values are less susceptible to noise and tend to be more stable. Median values tend to be less influenced by extreme values or outliers as compared to mean values. However, since pixel values are subjected to a quantification process, the median values may appear to be even more quantified, which will not be the case for the mean values. As such, it may be preferable to use the mean values. That the median values might appear to be even more quantified means that the median values might align closely with one of the specific quantization levels or intervals, making them appear more discrete or quantified.

As mentioned, the image portions can be obtained from a burst of images within a very short period of time. To illustrate, if 240 image portions are used and the image capture device is capable of capturing images are a rate of 240 fps, then the burst can be captured in one second. Thus, it can be assumed that the image portions (e.g., objects captured therein) do not change (or change very little) between frames over the capture time. As such, any determined fluctuations in the representative values can be considered to be due to artificial lighting and the frequency of the fluctuations can be equal (e.g., approximately equal) to the frequency of the artificial light source.

At 706, spectral data are obtained based on the pixel series. That is, the pixel series (or normalized pixel series obtained therefrom, as further described herein) undergoes a transformation to the frequency domain, resulting in the spectral data. A mathematical technique, such as the Fast Fourier Transform (FFT), can be applied to convert pixel-domain data (i.e., the pixel series) into a frequency representation.

In an example, the pixel series may be pre-processed before being converted to the frequency domain. The pixel series may be normalized (e.g., so that the values are in the interval [0, 1]). Normalization refers to the scaling of the values of the pixels series to a standard range, which results in numerical stability. By normalizing the pixel series, local large maxima and minima in the pixel series can be eliminated or reduced therewith enhancing the FFT analysis. Large (extreme) values may introduce noise or distortions that could affect the accuracy or interpretation of the FFT results.

To normalize the pixel series (denoted s), a (truncated) pixel series (denoted Ŝ_{α}) is first computed based on the mean (denoted μ(s)), the standard deviation (denoted σ(s)) of the pixel series, and a normalization parameter (denoted α). The normalization parameter α is empirically derived. In an example, the normalization parameter α can be 3 (i.e., α=3). The normalization parameter can be selected so as to remove outlier values. If the normalization parameter α is too small, then more data points may be excluded and only those close to the mean may be retained. On the other hand, if the normalization parameter α is too large, no data points may be excluded. The pixel series is truncated to retain values that are within a range [−τ_{α}, τ_{α}], where the threshold τ_{α} is calculated using equation (1). The normalized pixel series (denoted \tilde{S}_{α}) can then be obtained using equation (2).

$${τ}_{α} = μ ( s ) + α \times σ ( s ) \qquad ( 1 )$$

$${\tilde{s}}_{α} = \frac{{\hat{s}}_{α} - min ( {\hat{s}}_{α} )}{max ( {\hat{s}}_{α} ) - min ( {\hat{s}}_{α} )} \qquad ( 2 )$$

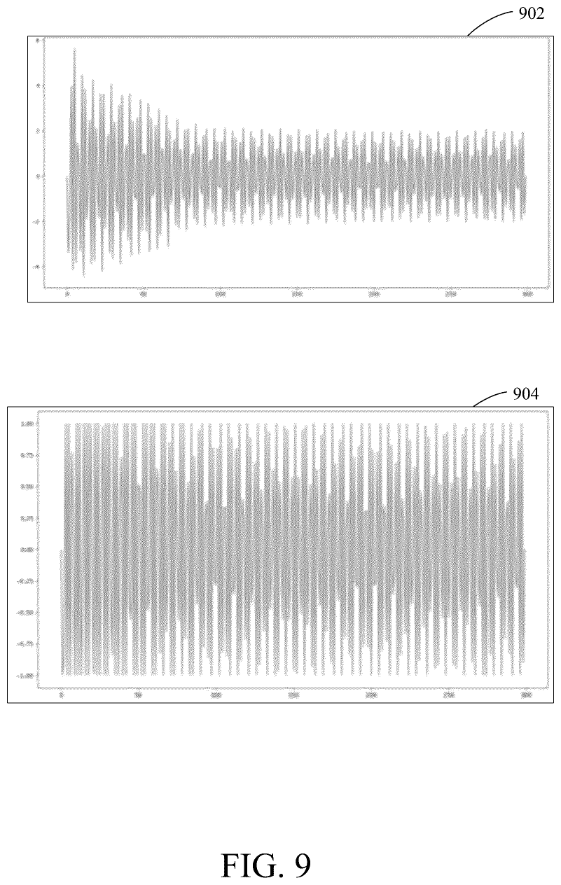

FIG. 9 illustrates examples of spectral data obtained from pixel series. A spectrum graph 902 illustrates a spectrum graph obtained from pixel series that are not truncated and normalized. On the other hand, a spectrum graph 904 illustrates a spectrum graph obtained from pixel series that have been truncated and normalized.

At 708, significant local maxima are identified in the spectral data. The spectral data can be used to identify an artificial frequency over the oscillation of the pixel series. As already described, due to the presence of both negative and positive fluctuations in a power supply, the frequency of artificial light can be twice that of the power frequency (i.e., the standard frequency at which AC electrical power is generated). For example, with a 50 Hz (or 60 Hz) power supply, an oscillation of 100 Hz (or 120 Hz) would be expected in the spectral data. It is noted that if a burst of image portions includes mixed lighting (e.g., sunlight and an artificial light), then another peak will be present for the 0 Hz frequency corresponding to the natural (e.g., sun) light.

A Gaussian filter may be applied to the spectral data such as to reduce noise. The spectral data can be convolved with the Gaussian filter. The Gaussian distribution can have a small standard deviation. In an example, the standard deviation can be 1.5 (i.e., σ=1.5). However, other standard deviation values are possible. Smoothing the spectral data with the Gaussian filter removes unwanted local maxima that may be due to noise in the pixel series.

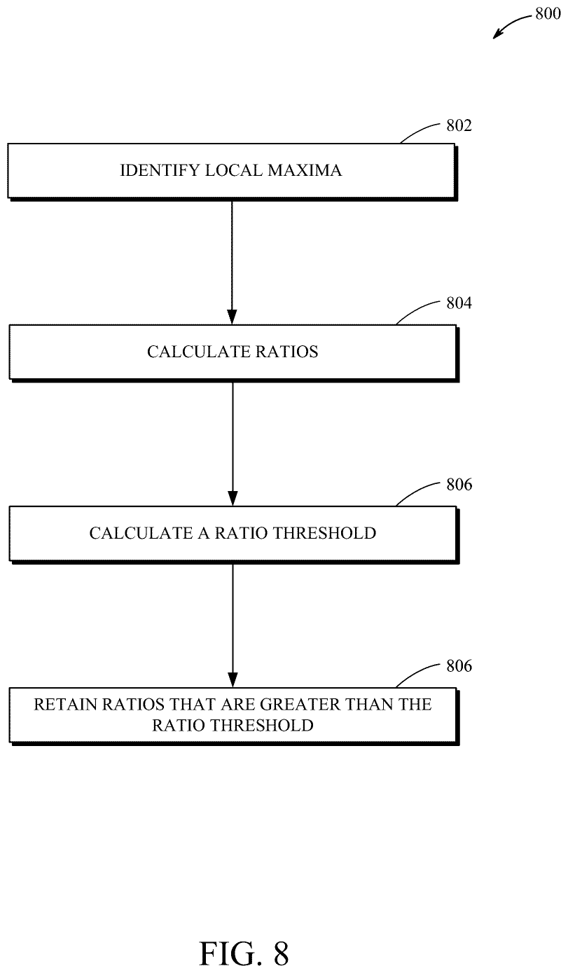

As mentioned, differentiation between natural and artificial lighting and the estimation of the frequency for the artificial lighting can be based on identifying the significant local maxima. In an example, since the central peak (corresponding to the frequency of natural light) can be disproportionate relative to other frequencies and since the spectral data (e.g., the FFT data) is symmetrical, only one half (e.g., the first or left half of the spectral data) without the central frequency is analyzed. FIG. 8 is a flowchart of a technique 800 for identifying significant local maxima in spectral data.

At 802, local maxima are identified. More accurately, frequencies corresponding to the local maxima are identified. A local maximum is identified at a frequency (e.g., a frequency value, or x-axis value) where the magnitude of the frequency (e.g., the y-axis value) is higher than the magnitude of the neighboring left and right frequencies. Thus, the local maxima can be identified using equation (4), where ƒ represents a frequency value and α(ƒ) represents the magnitude of the frequency:

$$\{ \begin{matrix}a ( f ) > a ( f - 1 ) \\ a ( f ) > a ( f + 1 )\end{matrix} \qquad ( 4 )$$

At 804, ratios are calculated. For each of the identified local maxima, a respective ratio (denoted r_{ƒ}) is obtained (e.g., calculated, determined, etc.) according to equation (5). A ratio r_{ƒ} provides information regarding the relative magnitudes or proportions between a value α(ƒ) and its neighboring values, α(ƒ−1) and α(ƒ+1). That is, a ratio for frequency ƒ is defined as the minimal ratio amongst a left ratio of the magnitude of the frequency (i.e., α(ƒ)) to the magnitude of its left neighboring frequency (i.e., α(ƒ−1)) and a right ratio of the magnitude of the frequency (i.e., α(ƒ)) to the magnitude of its right neighboring frequency (i.e., α(ƒ+1)).

$${r}_{f} = min ( \frac{a ( f )}{a ( f - 1 )} , \frac{a ( f )}{a ( f + 1 )} ) \qquad ( 5 )$$

A ratio rƒ is indicative of whether the local maximum is significant or not. As mentioned, there can be noise in the FFT therewith potentially resulting in many local maxima. The ratios can be used to keep (e.g., retain) those maxima whose ratios are bigger than a threshold (e.g. the local maxima that are significant). In equation (5), the locality considered is small and corresponds to a 1×3 filter with one left neighbor and one right neighbor considered. However, in an example, a larger neighborhood can be considered. The locality can be 1×N, where N is an odd number that is greater than 3. The larger the neighborhood the more significant the local maxima because they are larger than a larger portion of their respective neighborhoods. It is noted that a larger neighborhood translates to additional computational cost.

At 806, a ratio threshold is calculated. The ratio threshold γ_{β} is calculated over the mean (denoted μ({rᵢ}_{i≠M})) and the standard deviation (denoted σ({rᵢ}_{i≠M})) of the ratios from which the highest ratio (denoted r_{M}) has been removed. The highest ratio may be removed because it corresponds to the frequency of the natural light. The highest ratio may be removed to remove the central peak at zero. In an alternative approach, the FFT on [10 Hz, 120 Hz] may be considered instead of [0 Hz, 120 Hz]. When there is no aliasing, by removing the central portion [0 Hz, 10 Hz] the central peak which may be bigger than the others peaks is removed. Other techniques for detecting with accuracy the significant peaks of the FFT and checking whether the detected peaks are close to 100 Hz or 120 Hz.

The ratio threshold γ_{β} can be calculated using equation (6). In equation (6), β is a parameter that is empirically derived. In an example, the parameter α can be 5 (i.e., =5). Smaller values of the parameter β will lower the threshold therewith allowing for more values to be detected as significant. On the other hand, higher values of the parameter β will increase the threshold therewith allowing for less values to be detected as significant. Some artificial lighting may have peaks with low ratios (such as because the input signal may be noisy), while some natural lighting may have noise peaks with ratios that are close to those peaks. Thus, a problem is then how to capture all the peaks of artificial signals while discarding all natural lighting signals peaks. Properly selecting the parameter solves the problem.

γ_{β}=μ({rᵢ}_{i≠M})+βσ({rᵢ}_{i≠M}) (6)

At 808, ratio filtering is performed to retain the ratios that are greater than the ratio threshold. The retained ratios are identified as the significant local maxima (i.e., the local peaks). The central peak can also be retained.

At 710, artificial light is determined to be captured in the set of image portions in response to determining that a number of the significant local maxima being greater than one. If the number of the significant local maxima is one, then only natural light is captured in the scene (i.e., in the set of image portions).

At 712, an anti-flicker feature of the image capture device is enabled in response to determining that the artificial light is captured in the set of image portions. In an example, and as mentioned above, the image capture device may be configured to perform anti-flicker with respect to a particular power source. That is the image capture device may be configured to perform anti-flicker with respect to a default frequency. In an another example, the technique 700 may also identify the frequency of the artificial light. That is, in addition to determining that the scene includes artificial light, the frequency of the artificial light is also determined (e.g., estimated). The frequency of the power source generating the artificial light can be estimated to be or correspond to the frequency of the detected peaks that is different from the central peak. As such, the anti-flicker feature of an image capture device can also be configured to mitigate (e.g., reduce or cancel) the effect of flickering at the estimated frequency.

In an implementation, a different approach (than the one described above and that is based on obtaining significant local maxima) a low range peak corresponding to a largest amplitude in a low frequency range (e.g., in the range [0 Hz, 10 Hz) may be identified; and a high range peak corresponding to a largest amplitude in a high frequency range (e.g., (10 Hz, max frequency range] may be identified. A ratio of the high range peak to the low range peak can be indicative of the frequency of the artificial light source. If the ratio is greater than an empirically identified threshold, then it can be determined that artificial light exists in the scene. The frequency of the artificial light source can be estimated to be the closest possible artificial light source to the high range peak divided by 2.

In some examples, less than 240 frames may be processed by the technique 700. In an example, the image capture device may capture images at a 240 fps. However, the technique 700 may use less than the 240 frames. That is, the set of image portions may be obtained based on a frame rate that is slower than a frequency of a power generating the artificial light. In an example, a frame rate per second that is below 240 can be obtained through decimation from an original signal sampled at 240 fps. In another example, the burst of images may be obtained at a lower frame rate. When frames are captured at less than 240 fps (such as 120 fps, 50 fps, or some other fps that is lower than 240), the peaks may shift. In an example, the technique 700 may use 50 frames (e.g., 50 image portions) to reduce the computational complexity.

It may be possible to estimate illumination frequency from its alias frequency. If ƒₛ denotes the sampling frequency of the image capture device, and ƒₗ denotes the frequency of a light source, then ƒ_{α}, the aliased frequency of illumination can be obtained using formula (7).

$$∃ k ∈ ℕ , {f}_{a} = \vert {f}_{l} - k \times {f}_{s} \vert < \frac{{f}_{s}}{2} \qquad ( 7 )$$

That is, if the technique 700 uses image portions acquired at a frequency of ƒₛ, then for different values of k, if the calculated ƒ_{α} is a certain value, then the frequency of the light source can be assumed to be ƒₗ. Thus, to use a lower frame rate, the technique 700 can identify the significant local maxima as described above. The significant local maxima will correspond to the aliased frequency ƒₐ. Table I illustrates different possible theoretical values based on formula (7).

To illustrate how Table I could be used, if the frame rate were 48 fps (e.g., ƒₛ=48) and the significant local maxima is identified to be at 4 (e.g., ƒ_{α}=4), then the frequency of the light source can be determined to be 50 Hz (e.g., ƒₗ=100); on the other hand, if the significant local maxima is identified to be at 24 (e.g., ƒ_{α}=24), then the frequency of the light source can be determined to be 60 Hz (e.g., ƒₗ=120).

TABLE I

| Light Source Frequency of | | | Light Source Frequency of | | |
|---|---|---|---|---|---|
| 50 Hz (f_l = 100) | | | 60 Hz (f_l = 120) | | |
| FPS | | | FPS | | |
| Acquisition | | Alias | Acquisition | | Alias |
| (fₛ) | k | Frequency fₐ | (fₛ) | k | Frequency fₐ |
| 240 | 0 | 100 | 240 | 0 | 120 |
| 120 | 1 | 20 | 120 | 1 | 0/undefined |
| 80 | 1 | 20 | 80 | 1 | 40 |
| 60 | 2 | 20 | 60 | 2 | 0/undefined |
| 48 | 2 | 4 | 48 | 2 | 24 |
| 30 | 3 | 10 | 30 | 4 | 0/undefined |

Table I indicates that it may not be possible to distinguish a 60 Hz light source from a natural light source when certain frame rates (e.g., 120, 60, and 30) are used since each of those frame rates shares at least one common multiple with 60 Hz. Stated another way, Table I illustrates the fact that some FPS are not usable to discriminate between natural and artificial sources. As such, in an example, if the technique 700 determines that the alias frequency ƒ a is zero (or close to zero), then the technique 700 is re-performed where the image portions are captured (e.g., obtained) at a different rate. In an example, the technique 700 may re-configure the image capture device to use a different frame rate. For example, the technique 700 may re-configure the image capture device to use a frame rate of 50 fps. In an example, the

Again, Table I illustrates the fact that some FPS are not usable to discriminate between natural and artificial sources. To detect whether artificial light is present and a frequency therefor, the image capture device is preferably configured with an fps that is the lowest possible to reduce the power/time consumption of flicker detection as described herein; allows to have different alias frequencies for each of the 50 Hz and 60 Hz artificial light sources where the alias frequencies are as far as possible from 0 Hz (to easily discriminate between natural and artificial lighting); and allows to have different alias frequencies that are as far apart as possible for each of 50 Hz and 60 Hz signals (so that the 50 Hz and 60 Hz can be discriminated). A 44 fps results in an alias frequency of 12 Hz for each of 50 Hz and 60 Hz. Thus, the 44 fps is not acceptable (e.g., does not meet the listed criteria). The image capture device may be configured to a frame rate of 45 fps which results in alias frequencies of 10 Hz and 15 Hz for a 50 Hz and 60 Hz signals, respectively.

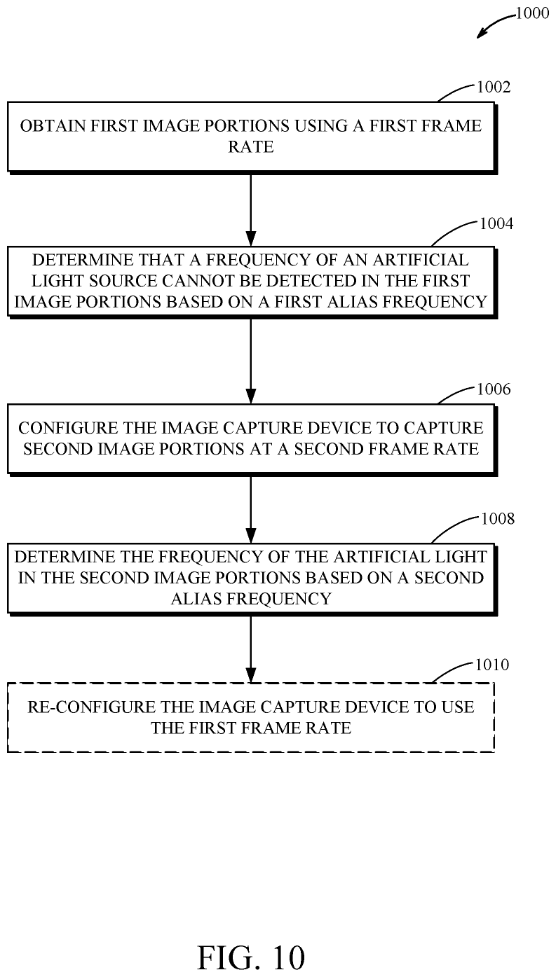

Accordingly, FIG. 10 is a flowchart of a technique 1000 for identifying a frequency of an artificial power source based on an alias frequency. At 1002, first image portions are obtained using a first frame rate. The first frame rate can be less than 240 fps. At 1004, the technique 1000 determines that the frequency of the artificial light source cannot be detected (e.g., calculated) in the first image portions based on a first alias frequency. Significant local maxima and the first alias frequency can be obtained as described above with respect to the FIG. 7 and Table I.

At 1006, responsive to determining that the frequency of the artificial light source cannot be detected, the image capture device can be configured to a second frame rate. At this point, the technique 700 can be repeated based on second image portions obtained according to the second frame rate. At 1008, the frequency of the artificial light can be determined in the second image portions based on a second alias frequency. It is noted that, if the frequency of the artificial light cannot be determined in the second image portions based on the second alias frequency, then the steps 1006-1008 may be repeated. At 1010, the technique 1000 may optionally re-configure (e.g., reset) the image capture device to the first frame rate.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include obtaining a set of image portions. The method may include obtaining a pixel series having respective representative values of the image portions. The method may include obtaining spectral data based on the pixel series. The method may include identifying significant local maxima in the spectral data. The method may include determining that an artificial light is captured in the set of the image portions in response to determining that a number of the significant local maxima is greater than one. The method may include enabling an anti-flicker feature of an image capture device in response to determining that the artificial light is captured in the set of the image portions. Other embodiments of this aspect include corresponding computer systems, apparatus, and computer programs recorded on one or more computer storage devices, each configured to perform the actions of the methods.

Implementations may include one or more of the following features. The method where the respective representative values are one of respective median values or respective mean values of pixel values of the image portions. The method where respective image portions may include of pixel values of one color channel. The method where the one color channel is a green color channel. The method where obtaining the respective representative values for the image portions may include: removing large maxima and minima in the pixel series by truncating the pixel series based on a truncation parameter. The method may include: determining a frequency of a light source based on the significant local maxima. The method where obtaining the set of the image portions may include: obtaining the set of the image portions based on a frame rate that is lower than a frequency of a light source generating the artificial light. Implementations of the described techniques may include hardware, a method or process, or a computer tangible medium.

In one general aspect, an image capture device may include a processor configured to execute instructions to: obtain spectral data from image data of a scene captured by the image capture device; determine, based on the spectral data, that artificial light exists in the scene; and in response to the determination that the artificial light exists in the scene, activate an anti-flicker function of the image capture device. Other embodiments of this aspect include corresponding computer systems, apparatus, and computer programs recorded on one or more computer storage devices, each configured to perform the actions of the methods.

Implementations may include one or more of the following features. The image capture device where to activate the anti-flicker function may include to: identify a frequency associated with the artificial light; and configure the anti-flicker function to synchronize image capture of the image capture device according to the frequency associated with the artificial light. The image capture device where to determine that the artificial light exists in the scene may include to: obtain a time series of respective representative pixel values of the image data; obtain a frequency spectrum from the time series; obtain frequency amplitudes from the frequency spectrum; select a prominence value for peak detection; select a threshold value; associate peaks identified in frequency spectrum to corresponding amplitudes; identify a low range peak corresponding to a highest amplitude within a range of low frequencies; identify a high range peak corresponding to a highest amplitude within a range of high frequencies; and determine that the artificial light exists in the scene based on a ratio of the high range peak to the low range peak. The image capture device where the processor is further configured to execute instructions to: configure the image capture device to capture image data at a frame rate that is at least double a peak frequency identified based on the spectral data. The image capture device where to activate the anti-flicker function of the image capture device may include to: configure the anti-flicker function based on a peak frequency identified based on the spectral data. The image capture device where to determine based on the spectral data that the artificial light exists in the scene may include to: determine that the artificial light exists in the scene in response to identifying a significant peak proximal to a predefined frequency in the spectral data. The image capture device where the predefined frequency is 100 Hz or 120 Hz. Implementations of the described techniques may include hardware, a method or process, or a computer tangible medium.

In one general aspect, a non-transitory computer readable medium that stores instructions operable to cause one or more processors to perform operations to obtain spectral data based on a pixel series, where the pixel series includes respective representative values corresponding to image portions; identify significant local maxima in the spectral data; and configure an anti-flicker feature of an image capture device in response a determination that a number of the significant local maxima is greater than one. Other embodiments of this aspect include corresponding computer systems, apparatus, and computer programs recorded on one or more computer storage devices, each configured to perform the actions of the methods.

Implementations may include one or more of the following features. The non-transitory computer readable medium where the respective representative values are one of respective mean pixel values corresponding to the image portions or respective median pixel values corresponding to the image portions. The non-transitory computer readable medium where respective image portions may include of pixel values of one color channel. The non-transitory computer readable medium where the operations may include to: remove large maxima and minima in the pixel series by truncating the pixel series based on a truncation parameter. The non-transitory computer readable medium where the operations may include to: determine a frequency of a light source based on the significant local maxima. The non-transitory computer readable medium where the operations may include to: obtain the image portions based on a frame rate that is slower than a frequency of a light source generating artificial light, where the frequency is identified based on the significant local maxima. Implementations of the described techniques may include hardware, a method or process, or a computer tangible medium.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This description should be read to include one or at least one and the singular also includes the plural unless it is obvious that it is meant otherwise.

Upon reading this disclosure, those of skill in the art will appreciate still additional alternative structural and functional designs for a system and a process for reducing the total latency for transferring a frame from the low latency camera system mounted on an aerial vehicle to the display of the remote controller through the disclosed principles herein.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
obtaining a set of image portions;
obtaining a pixel series comprising respective representative values of the image portions;
obtaining spectral data based on the pixel series;
identifying significant local maxima in the spectral data;
determining that an artificial light is captured in the set of the image portions in response to determining that a number of the significant local maxima is greater than one; and
enabling an anti-flicker feature of an image capture device in response to determining that the artificial light is captured in the set of the image portions.

2. The method of claim 1, wherein the respective representative values are one of respective median values or respective mean values of pixel values of the image portions.

3. The method of claim 1, wherein respective image portions consist of pixel values of one color channel.

4. The method of claim 3, wherein the one color channel is a green color channel.

5. The method of claim 1, wherein obtaining the respective representative values for the image portions comprises:
removing large maxima and minima in the pixel series by truncating the pixel series based on a truncation parameter.

6. The method of claim 1, further comprising:
determining a frequency of a light source based on the significant local maxima.

7. The method of claim 1, wherein obtaining the set of the image portions comprises:
obtaining the set of the image portions based on a frame rate that is lower than a frequency of a light source generating the artificial light.

8. An image capture device, comprising:
a processor configured to execute instructions to:
obtain spectral data from image data of a scene captured by the image capture device;
determine, based on the spectral data, that artificial light exists in the scene; and
in response to the determination that the artificial light exists in the scene, activate an anti-flicker function of the image capture device.

9. The image capture device of claim 8, wherein to activate the anti-flicker function comprises to:
identify a frequency associated with the artificial light; and
configure the anti-flicker function to synchronize image capture of the image capture device according to the frequency associated with the artificial light.

10. The image capture device of claim 8, wherein to determine that the artificial light exists in the scene comprises to:
obtain a time series of respective representative pixel values of the image data;
obtain a frequency spectrum from the time series;
obtain frequency amplitudes from the frequency spectrum;
select a prominence value for peak detection;
select a threshold value;
associate peaks identified in frequency spectrum to corresponding amplitudes;
identify a low range peak corresponding to a highest amplitude within a range of low frequencies;
identify a high range peak corresponding to a highest amplitude within a range of high frequencies; and
determine that the artificial light exists in the scene based on a ratio of the high range peak to the low range peak.

11. The image capture device of claim 8, wherein the processor is further configured to execute instructions to:
configure the image capture device to capture image data at a frame rate that is at least double a peak frequency identified based on the spectral data.

12. The image capture device of claim 8, wherein to activate the anti-flicker function of the image capture device comprises to:
configure the anti-flicker function based on a peak frequency identified based on the spectral data.

13. The image capture device of claim 8, wherein to determine based on the spectral data that the artificial light exists in the scene comprises to:
determine that the artificial light exists in the scene in response to identifying a significant peak proximal to a predefined frequency in the spectral data.

14. The image capture device of claim 13, wherein the predefined frequency is 100 Hz or 120 Hz.

15. A non-transitory computer readable medium storing instructions operable to cause one or more processors to perform operations comprising operations to:
obtain spectral data based on a pixel series, wherein the pixel series includes respective representative values corresponding to image portions;
identify significant local maxima in the spectral data; and
configure an anti-flicker feature of an image capture device in response a determination that a number of the significant local maxima is greater than one.

16. The non-transitory computer readable medium of claim 15, wherein the respective representative values are one of respective mean pixel values corresponding to the image portions or respective median pixel values corresponding to the image portions.

17. The non-transitory computer readable medium of claim 15, wherein respective image portions consist of pixel values of one color channel.

18. The non-transitory computer readable medium of claim 15, wherein the operations further comprise to:
remove large maxima and minima in the pixel series by truncating the pixel series based on a truncation parameter.

19. The non-transitory computer readable medium of claim 15, wherein the operations further comprise to:
determine a frequency of a light source based on the significant local maxima.

20. The non-transitory computer readable medium of claim 15, wherein the operations further comprise to:
obtain the image portions based on a frame rate that is slower than a frequency of a light source generating artificial light, wherein the frequency is identified based on the significant local maxima.
